(19) United States
(12) Patent Application Publication
(10) Pub. No.: US 2013/0301715 A1
(43) Pub. Date: Nov. 14, 2013

(54) PREDICTION METHOD IN CODING OR DECODING AND PREDICTOR

(71) Applicant: Huawei Technologies Co., Ltd., Shenzhen (CN)

(72) Inventors: Yongbing LIN, Beijing (CN); Changcai Lai, Hangzhou (CN)

(21) Appl. No.: 13/940,272

(22) Filed: Jul. 12, 2013

Related U.S. Application Data
(63) Continuation of application No. PCT/CN2012/070391, filed on Jan. 16, 2012.

(30) Foreign Application Priority Data
Jan. 14, 2011 (CN) 201110007743.8

(51) Int. Cl. H04N 7/32

(52) U.S. Cl. CPC H04N 19/00569
USPC 375/240.12

(57) ABSTRACT

The present application provides a prediction method for use in an image block encoding or decoding process. The method includes obtaining availability information of reference blocks of a current image block, and determining whether the reference blocks are available according to the availability information, where the reference blocks of the current image block include a left side block, an upper side block, and an upper left block of the current image block; if at least one of the reference blocks is available, and at least one is unavailable, filling a pixel value in the available reference block to the unavailable reference block as a reference pixel value of the current image block; and predicting the current image block according to the reference pixel value.

### CROSS-REFERENCE TO RELATED APPLICATIONS

This application is a continuation of International Application No. PCT/CN2012/070391, filed on Jan. 16, 2012, which claims priority to Chinese Patent Application No. 201110007743.8, filed on Jan. 14, 2011, both of which are hereby incorporated by reference in their entireties.

### TECHNICAL FIELD

The present application relates to video encoding or decoding technologies, and in particular to a pixel prediction method in an encoding or decoding process.

### BACKGROUND

The basic principle for video code compression is to eliminate redundancy as much as possible by using relevance between space domain, time domain, and code word. Currently, a popular method of video code compression is to use a block-based mixed video coding framework to implement the video code compression through steps such as prediction, transformation, quantization, and entropy encoding. Such a coding framework shows strong vitality. Standards from the earliest MPEG-1 (Moving Picture Experts Group-1) to the latest video coding standard H.264/AVC (H.264/Advanced Video Coding), and even the next-generation video coding compression standard HEVC (High Efficiency Video Coding) under formulation by the JCTVC (Joint Collaborative Team on Video Coding) workgroup (a joint workgroup founded by MPEG and VECG (Video Coding Experts Group)) all use such a block-based mixed video coding framework.

In a video encoding or decoding process, a block-based space-domain prediction encoding technology is generally used, and the basic principle of the block-based space-domain prediction encoding is to eliminate space-domain redundancy by using relevance between neighboring blocks. That is, neighboring blocks are used as reference blocks to predict a current block. Currently, a raster-scan method is commonly used in video image encoding. Generally, the raster-scan process starts from the upper left corner of an image or slice, and proceeds according to a sequence from top to bottom and from left to right. Reference blocks of a current image block mainly include a left side block, an upper side block, and an upper left block.

Apparently, during the space-domain prediction for border blocks of the image, the problem of how to handle unavailable reference blocks will inevitably be involved, that is, the problem of how to obtain corresponding reference pixel values when some neighboring blocks of an image block are unavailable. Generally speaking, the so-called “unavailable” blocks occur in one of the following cases:

In a first case, reference blocks actually do not exist. In an existing practice, a frame of image is divided into multiple image blocks. For example, the block size for encoding an image may be set as 64×64 pixels (or other numbers). If a current image does not meet this dimension specification, some image blocks may be smaller than 64×64 pixels. These blocks need to be supplemented to the specified size of 64×64 pixels.

The values of the supplemented pixels are predicted by using neighboring reference blocks. However, in this case, image blocks located at the borders of the image will have neighboring blocks (used as reference blocks) that “should not exist”. If a pixel value of an image block is predicted according to these neighboring blocks that “should not exist”, an extremely large error may occur.

In a second case, reference blocks do exist, but the reference blocks and the current image block are in different slices of the image. For example, for a current block located at the border of a slice, its neighboring blocks may be located in other slices. In this case, the neighboring blocks and the current image block cannot be referenced mutually.

In a third case, the neighboring blocks are not processed (decoded or restructured) yet, and cannot serve as reference blocks.

If any one of the left side block, upper side block, and upper left block of a current image block falls in any of the preceding unavailable cases, the solution in the prior art is to directly assign an invariable reference pixel value, e.g. 128, for pixel points of the reference block, and the current block is predicted using the invariable value. Apparently, assigning an invariable value for pixel points of an unavailable reference block conflicts with the changing nature of image block pixels, and the prediction result can hardly meet actual requirements.

As shown in FIG. 1, a UDI (Unified Directional Intra) prediction technology is further proposed in the prior art. In the image prediction, one direction is selected among 33 possible prediction directions. Prediction for a pixel point in a current image block is performed based on reference blocks pointed to by the corresponding prediction direction.

This greatly improved prediction flexibility. However, with the 33 prediction directions, the prediction procedure may still possibly face a large number of “unavailable” reference blocks. If all of them are filled with invariable values, the accuracy of prediction will be greatly affected.

### SUMMARY

The present application provides a prediction method in an image block encoding or decoding process. The method includes: obtaining availability information of reference blocks of a current image block, and determining whether the reference blocks are available for predicting pixel values of the current image block according to the availability information, wherein the reference blocks of the current image block include a left side block, an upper side block, and an upper left block of the current image block; and if at least one of the reference blocks is available, and at least one is unavailable, filling a pixel value in the available reference block to the unavailable reference block as a reference pixel value of the current image block; and predicting the current image block according to the reference pixel value.

The present application further accordingly provides a predictor that uses the prediction method, including: an availability determining module, configured to obtain availability information about reference blocks of a current image block, and determine whether the reference blocks are available according to the availability information, where the reference blocks of the current image block include a left side block, an upper side block, and an upper left block of the current image block; a pixel value filling module, configured to: if at least one of the reference blocks is available, and at least one is unavailable, fill a pixel value in the available reference block to the unavailable reference block as a reference pixel value of the current image block; and a predicting module, configured to predict the current image block according to the reference pixel value.

The present application further provides a prediction method, including: obtaining a prediction direction; if the prediction direction points to an upper right block of the current image block, the upper right block is unavailable, and the left side block of the current image block is available, filling a pixel value of the left side block of the current image block to a lower side block of the current image block, and obtaining a pixel value of the lower side block pointed to by the prediction direction in reverse extension after filling; and predicting a pixel value of the current image block according to the pixel value of the lower side block pointed to by the prediction direction in reverse extension after filling and the prediction direction.

The present application further accordingly provides a predictor that uses the prediction method, including: a prediction direction obtaining module, configured to obtain a prediction direction;

a pixel value filling module, configured to: when the prediction direction points to an upper right block of a current image block, the upper right block is unavailable, and a left side block of the current image block is available, fill a pixel value of the left side block of the current image block to a lower side block of the current image block, and obtain a pixel value of the lower side block pointed to by the prediction direction in reverse extension after filling; and

a predicting module, configured to predict a pixel value of the current image block according to the pixel value of the lower side block pointed to by the prediction direction in reverse extension after filling and the prediction direction.

According to the prediction method and predictor provided in the present application, unavailable pixel blocks are filled by using pixel values of available reference blocks, so that pixel prediction may always be performed based on the pixel values of the reference blocks that are adjacent to the current block, improving the accuracy of the prediction.

### BRIEF DESCRIPTION OF THE DRAWINGS

To illustrate the technical solutions presented in various embodiments of the present application, the following accompanying drawings are referred to in describing the embodiments of the present application. Apparently, the accompanying drawings in the following description merely illustrate some embodiments of the present application, and persons of ordinary skill in the art can derive other drawings and embodiments from these accompanying drawings without creative efforts.

FIG. 1 is an application diagram of a UDI prediction method provided by the H.264 standard;

FIG. 2 is a schematic diagram of image block arrangement in image prediction;

FIG. 3 is a flow diagram of a prediction method according to a first embodiment of the present application;

FIG. 4 is an application diagram of a prediction method according to the first embodiment of the present application;

FIG. 5 is a flow diagram of a prediction method according to a second embodiment of the present application;

FIG. 6 is an application diagram of a prediction method according to the second embodiment of the present application;

FIG. 7 is a simplified block diagram of a predictor according to the first embodiment of the present application; and

FIG. 8 is a simplified block diagram of a predictor according to the second embodiment of the present application.

### DETAILED DESCRIPTION

First Embodiment

FIG. 2 is a schematic diagram of an arrangement of image blocks. Block E is a current image block, block A is a left side block of the current image block, block B is an upper block of the current image block, block D is an upper left block of the current image block, and block C is an upper right block of the current image block. Blocks A, B, C and D are reference blocks of block E. The prediction method provided in this embodiment provides a solution when any one reference block among the blocks A, B, and D is unavailable.

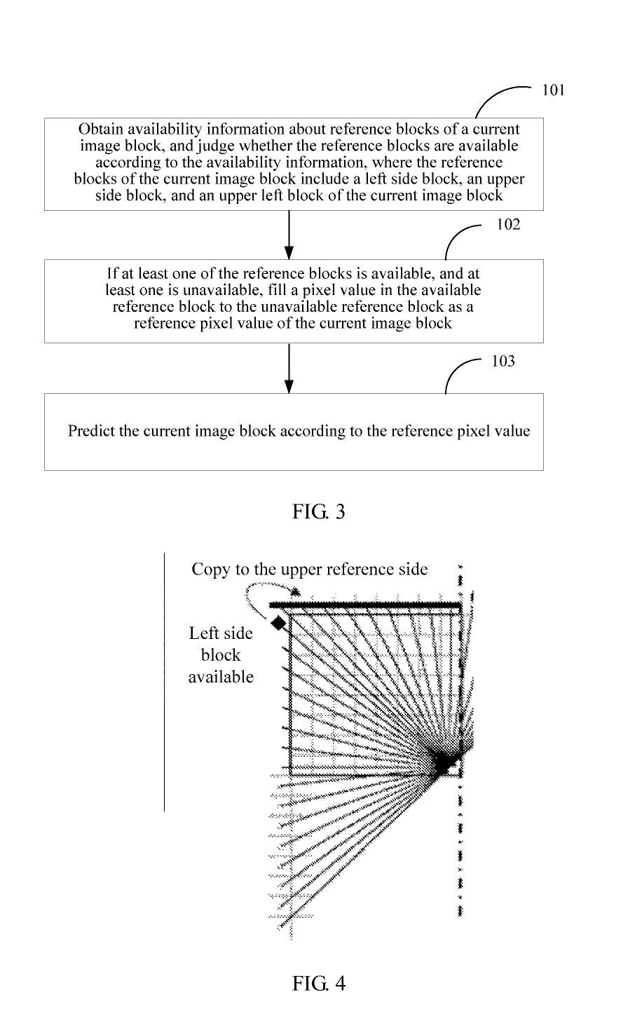

As shown in FIG. 3, the prediction method according to this embodiment includes:

Step 101: Obtain availability information of reference blocks of a current image block, and determine whether the reference blocks are available according to the availability information, where the reference blocks of the current image block include a left side block, an upper side block, and an upper left block of the current image block.

In this embodiment, the availability information may include some or all of: (1) whether a reference block is located inside a border of an image where the current image block is located; (2) whether the reference block and the current image block are located in a same slice of the image; and (3) whether the reference block has already been encoded or decoded.

If the reference block is located inside a border of an image where the current image block is located, the reference block and the current image block are located in a same slice of the image, and the reference block has already been encoded or decoded, the reference block is available. Otherwise, if any of the foregoing conditions are not met, the reference block is unavailable. From another aspect, to determine whether a reference block is located inside a border of an image where the current image block is located means to determine whether the reference block is an additionally supplemented image block that is located at the border of the image. For example, if a block size for image encoding or decoding is set at 64×64 pixels, and an image block is too small to meet this specification requirement, certain virtual image blocks that do not exist will be placed outside the border of the image block for prediction purposes. Obviously, these virtual image blocks that do not exist cannot be used to predict a pixel value of the current image block.

Step 102: If at least one of the reference blocks (such as blocks A, B and D) is available, and at least one is unavailable, fill a pixel value in the available reference block(s) to the unavailable reference block(s) as a reference pixel value of the current image block. Details of how to determine the pixel value for filling the unavailable block(s) will be discussed later.

Step 103: After filling the unavailable reference block(s) with the pixel value of the available reference block(s), predict the current image block according to the pixel values of the reference blocks.

For example, reference may be made to FIG. 4. When the left side block is available, but the upper side block is unavailable, a pixel value of the left side block as a reference block is filled to the upper side block. When the upper side block is available, but the left side block is unavailable, execution is performed accordingly.

According to the method provided in this embodiment, when any one of the left side block, upper side block, and upper left block of the current image block is unavailable, pixel values of other available reference blocks may be filled to the unavailable reference block according to certain rules as described below, ensuring that pixel prediction can still be performed based on neighboring blocks of the current block, and improving the accuracy of the pixel prediction.

Certainly, to further improve the accuracy of pixel prediction, when filling an unavailable reference block with pixel values in available reference block(s), a pixel value of a pixel point in an available reference block may be used. The pixel point may be such that it is nearest to the unavailable reference block and the current image block among all the pixels in the available reference blocks. It can be seen from the arrangement of image blocks as shown in FIG. 2, the left side block A, the upper side block B, and the upper left block C are all close to an upper left corner of the current image block E. Therefore, a pixel value that is used for filling an unavailable reference block (such as block B) may be obtained from a pixel point that is nearest to the pixel point at the upper left corner of the current image block among the available reference block(s) (such as block A), and the obtained pixel value is filled to the unavailable reference block.

It should be pointed out that, in the case where an image is divided into slices in a normal raster scan sequence, when one of the left side block and upper side block of a current block is unavailable, the upper left block of the current block is also unavailable. Therefore, the case where the upper left block and upper side block are available and the left side block is unavailable and the case where the upper left block and left side block are available and the upper side block is unavailable are unlikely to occur, and are not discussed herein.

As shown in FIG. 2, in some actual applications, if the left side block A is available, and the upper side block B is unavailable, fill certain pixel values of the left side block A to the upper side block B; if the upper side block B is available, and the left side block A is unavailable, fill certain pixel values of the upper side block B to the left side block A; if the upper left block D is unavailable, and one of the left side block A and upper side block B is available, fill certain pixel values of the available one of the left side block A and upper side block B to the upper left block D; and if the upper left block D is unavailable, and both the left side block A and upper side block B are available, obtain an average value for certain pixel values of the left side block A and upper side block B and fill it to the upper left block D.

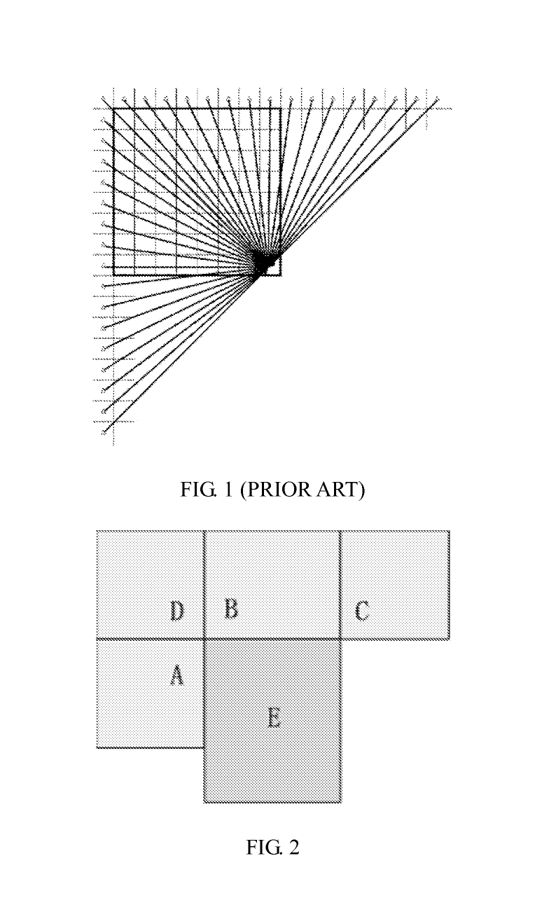

Particularly, to improve the accuracy of prediction, in the case of selecting pixel values for filling the reference blocks, the pixel value of a pixel point in a reference block among blocks A, B, and D may be selected, where the pixel point is nearest to the upper left corner of the current block E. For example, the pixel value of the pixel point at the upper right corner of the left side block A, the pixel value of the pixel point at the lower left corner of the upper side block B, and/or the pixel value of the pixel point at the lower right corner of the upper left block D may be selected. As shown in FIG. 1 and FIG. 2, the reference block filling method as introduced in this embodiment may be subsequently applied to image prediction, particularly in the UDI prediction method as introduced above. After filling the unavailable blocks among the upper left block, left side block, and upper side block of the current image block according to the method as described in this embodiment, the accuracy of UDI prediction may be improved. For several prediction directions that point to the upper right block at the right side in the UDI prediction, if the upper right block is unavailable, an invariable value or a pixel value that is nearest to the upper right corner may still be used for filling.

Second Embodiment

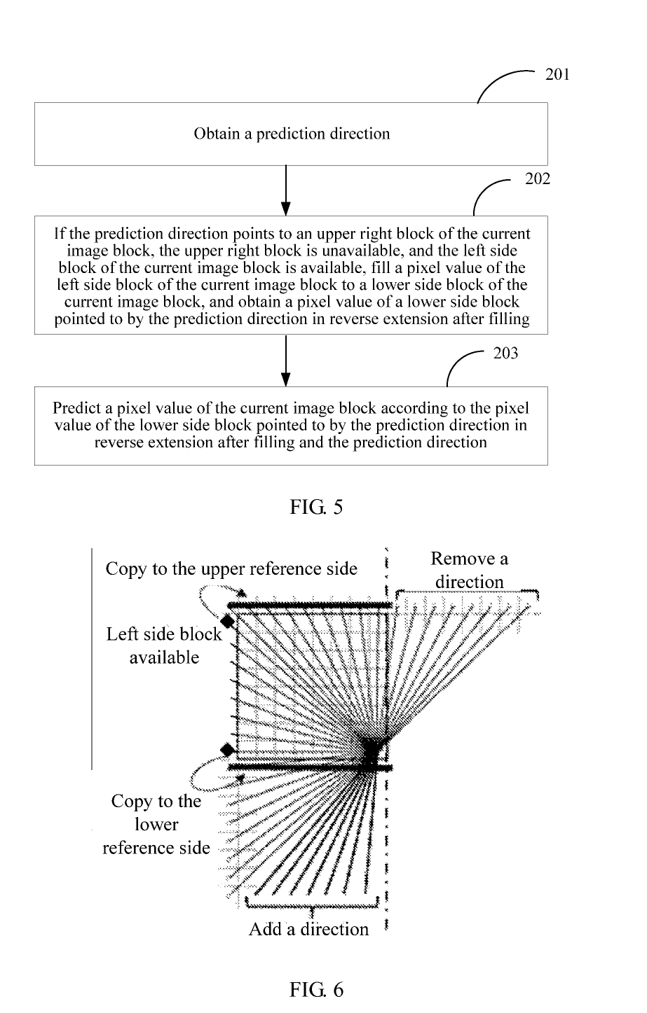

To further improve the accuracy of prediction, a second embodiment of the present application provides a prediction method which is modified from the conventional UDI prediction method. As shown in FIG. 5 and FIG. 6, the method includes:

Step 201: Obtain a prediction direction.

The prediction direction is a prediction direction of a certain pixel point of the current image block. It can be learned according to the UDI technology, introduced above, that the prediction of each pixel point in the current image block is performed according to certain pixel points of the reference blocks. The pixel points of the reference blocks are pointed to by one of 33 prediction directions as shown in FIG. 1.

Step 202: Referring to FIG. 2, if the prediction direction points to an upper right block C of the current image block E, and the upper right block C is unavailable while the left side block A of the current image block E is available, fill certain pixel values of the left side block A of the current image block E to a lower side block of the current image block E (the block directly under block E, not shown in FIG. 2), and obtain an after-filling pixel value of a pixel in the lower side block pointed to by a direction which is a reversed extension of the prediction direction.

Step 203: Predict a pixel value of the current image block E according to the after-filling pixel value of the lower side block pointed to by the direction which is the reversed extension of the prediction direction.

In this embodiment, the upper right block C is actually also a reference block of the current image block E. Therefore, the method for determining whether the upper right block C is unavailable is the same as the method for determining whether a reference block (A, B, or D) is available according to the previous embodiment. That is, determine whether the upper right block C is available based on availability information which includes: whether the upper right block C is located outside a border of an image where the current image block E is located; whether the upper right block C is located at a different slice from the current image block E; and/or whether the upper right block C has not been encoded or decoded. If the upper right block C is located inside a border of an image where the current image block E is located, the upper right block C and the current image block E are located in a same slice of the image, and the upper right block C has already been encoded or decoded, the upper right block is available. Otherwise, if any of the foregoing conditions are not met, the upper right block C is unavailable.

For a specific application example, reference may be made to FIG. 6. When using the UDI prediction method to predict a pixel value of a pixel point in the current image block E, if the prediction direction of the pixel point points to the upper side block B and left side block A of the current image block E, the prediction method according to the first embodiment may be used for prediction. If the prediction direction points to the upper right block C and the upper right block C is unavailable, the prediction direction is reversed to point to the image block under the current image block E, and prediction is performed according to pixel values of pixel point that are adjacent to the current image block E, as pointed to by the reversed prediction direction, and the pixel points are in the lower side block (the block under the current image block E). Certainly, if the lower side block is unavailable, a pixel value of a pixel point of the corresponding lower side block may be filled according to a pixel value of the left side block.

According to the prediction method provided in this embodiment, when the upper right block C pointed to by the prediction direction is unavailable, certain pixel values of pixel points of the lower side block pointed to reversely are acquired for prediction. If the lower side block is unavailable, certain pixel values of pixel points in the left side block A are filled in the lower side block. In addition, the current image block E is predicted according to the prediction direction and the pixel values after the filling.

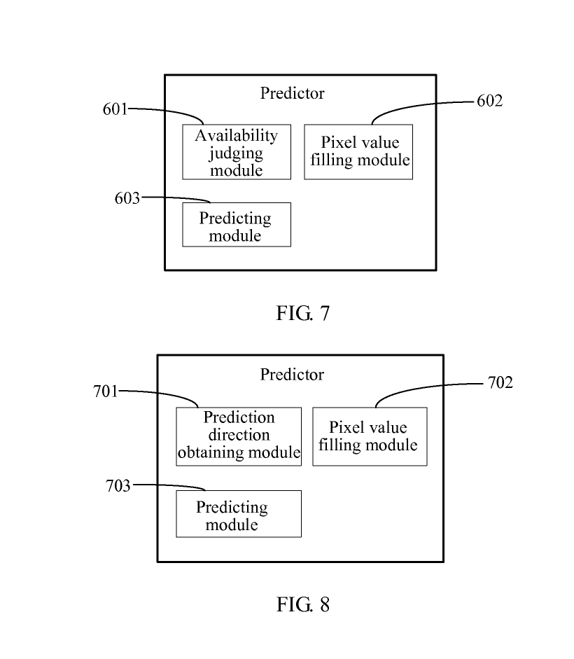

As shown in FIG. 7, according to the present application, an apparatus is provided. The apparatus, configured to execute the method provided in the first embodiment of the present application, includes:

an availability determining module 601, configured to obtain availability information of reference blocks of a current image block, and determine whether each of the reference blocks is available according to the availability information, wherein the reference blocks of the current image block include a left side block, an upper side block, and an upper left block of the current image block;

a pixel value filling module 602, configured to: if at least one of the reference blocks is available, and at least one is unavailable, fill a pixel value of a pixel point in the available reference block to a corresponding pixel point in the unavailable reference block as a reference pixel value of the current image block; and

a predicting module 603, configured to predict the current image block according to the reference pixel value.

The availability information may include: (1) whether a reference block is located inside a border of an image where the current image block is located; (2) whether the reference block is located in a same slice with the current image block; and (3) whether the reference block has already been encoded or decoded. If the reference block is located inside a border of an image where the current image block is located, the reference block and the current image block are located in a same slice of the image, and the reference block has already been encoded or decoded, the reference block is available; otherwise, the reference block is unavailable. From another aspect, whether a reference block is located inside a border of an image where the current image block is located means to determine whether the reference block is an additionally supplemented image block that is located at the border of the image. A current image specification for an encoding or decoding process is 64×64. An image may fail to meet this specification requirement. In this case, certain virtual image blocks that do not originally exist may be added outside the border of the image. Apparently, these image blocks that do not originally exist may not be used to predict a pixel value of the current image block.

As shown in FIG. 8, relative to the UDI prediction technology, an apparatus for predicting image pixel values in an encoding or decoding process according to the second embodiment of the present application is provided. The apparatus includes:

a prediction direction obtaining module 701, configured to obtain a prediction direction;

a pixel value filling module 702, configured to: when the prediction direction points to an upper right block of the current image block, the upper right block is unavailable, and the left side block of the current image block is available, fill a pixel value of the left side block of the current image block to a lower side block of the current image block, and obtain a pixel value of the lower side block pointed to by the prediction direction in reversed extension after filling; and

a predicting module 703, configured to predict a pixel value of the current image block according to the pixel value of the lower side block pointed to by the prediction direction in reversed extension after filling and the prediction direction.

According to the description of the embodiments, persons skilled in the art can clearly understand that the present application may be implemented by software on a necessary universal hardware platform or by hardware only. In most circumstances, the former is preferred. Based on such understanding, the technical solutions in the present application essentially, or the part contributing to the prior art may be embodied in a form of a software product. The computer software product is stored in a storage medium, such as a ROM/RAM, a magnetic disk, or an optical disk, and includes several instructions for instructing a computer device (which may be a personal computer, a server, a network device, and the like) to execute the methods described in all or some parts of the embodiments of the present application.

The above are merely exemplary embodiments of the present application. It should be noted that improvements and modifications can also be made by persons of ordinary skill in the art within the principle of the present application, and shall fall within the protection scope of the present application.

What is claimed is:

1. In an image encoding or decoding process, an image block prediction method comprising:
for a pixel point in a current image block, determining a corresponding pixel point in a reference block, wherein the current image block has a left side block, an upper side block, and an upper left block as its neighboring blocks, and the reference block is one of the neighboring blocks;
obtaining availability information of the neighboring blocks of the current image block and determining whether the reference block is available according to the availability information;
if the reference block is unavailable, and at least one other neighboring block is available, obtaining a pixel value of a pixel point in an available neighboring block, and filling the corresponding pixel point in the unavailable reference block with the obtained pixel value of the pixel point in the available neighboring block as a reference pixel value of the pixel point in the current image block; and
predicting the pixel value of the pixel point in the current image block based on the reference pixel value.

2. The method according to claim 1, wherein a neighboring block is available as a reference block if the neighboring block is located inside the image where the current image block is located, the neighboring block and the current image block are located in the same slice of the image, and the neighboring block has already been encoded or decoded.

3. The method according to claim 1, wherein a neighboring block is unavailable as a reference block if:
the neighboring block is located outside the image where the current image block is located, or
the neighboring block and the current image block are located in different slices of the image, or
the neighboring block has not already been encoded or decoded.

4. The method according to claim 1, wherein filling the corresponding pixel point in the unavailable reference block with the obtained pixel value in the neighboring block comprises:
when the upper side block is the unavailable reference block, and if the left side block is available, filling the corresponding pixel point in the upper side block with the obtained pixel value of the pixel point in the left side block;
when the left side block is the unavailable reference block, and if the upper side block is available, filling the corresponding pixel point in the left side block with the obtained pixel value of the pixel point in the upper side block;
when the upper left block is the unavailable reference block, and one of the left side block and upper side block is available, filling the corresponding pixel point in the upper left block with the obtained pixel value of the pixel point in the available one of the left side block and upper side block; and
when the upper left block is the unavailable reference block, and both the left side block and upper side block are available, obtaining an average value for the pixel values of the pixel point in the left side block and the pixel point in the upper side block and filling the corresponding pixel point with the average value.

5. The method according to claim 4, wherein obtaining an average value for the pixel values of the pixel point in the left side block and the pixel point in the upper side block and filling the corresponding pixel point with the average value comprises:
obtaining a pixel value of a pixel point in the left side block that is closest to a pixel point at an upper left corner of the current image block and a pixel value of a pixel point in the upper side block that is closest to the pixel point at the upper left corner of the current image block, and calculate an average value of the two pixel values; and
filling the average value to a lower right corner of the upper left block.

6. The method according to claim 1, wherein the method is used in an intra prediction mode of the encoding or decoding process.

7. The method according to claim 6, wherein the corresponding pixel point in the reference block is a pixel point located along a prediction direction, and is closest to the current image block.

8. The method according to claim 1, wherein obtaining a pixel value of a pixel point in an available neighboring block, and filling the corresponding pixel point in the unavailable reference block with the obtained pixel value of the pixel point in the available neighboring block comprises:
obtaining a pixel value from pixel points in the available neighboring block that are nearest to a pixel point at an upper left corner of the current image block; and
filling the pixel value to the corresponding pixel point in the unavailable reference block.

9. The method according to claim 1, wherein the image encoding or decoding process is proceeded by a raster scan order.

10. In an image encoding or decoding process, an image block prediction method, comprising:
for a pixel point in a current image block, determining a corresponding pixel point in a reference block according to a predetermined prediction direction, wherein the current image block has a left side block, an upper side block, an upper left block and a upper right block as its neighboring blocks, and the reference block is one of the neighboring blocks;
if the prediction direction points to the upper right block as the reference block, the upper right block is unavailable, and the left side block is available, reversing the prediction direction so that it points to a lower side block of the current image block;
obtaining a pixel value of a pixel point in the left side block, and filling a pixel point in the lower side block of the current image block which the reversed prediction direction points to with the obtained pixel value as a reference pixel value of the pixel point in the current image block; and
predicting the pixel value of the pixel point in the current image block according to the reference pixel value.

11. The method according to claim 10, wherein the upper right block is unavailable if:
the upper right block is located outside an image where the current image block is located; or
the upper right block and the current image block are located at different slices of the image; or
the upper right block has not been encoded or decoded.

12. An apparatus for encoding or decoding an image, comprising a non-transitory medium storing a software program for predicting pixel values of pixel points in image blocks, the program comprising the following functional modules:
a determining module, configured to, for a pixel point in a current image block, determine a corresponding pixel point in a reference block, wherein the current image block has a left side block, an upper side block, and an upper left block as its neighboring blocks, and the reference block is one of the neighboring blocks,
an obtaining module, configured to obtain availability information of the neighboring blocks of the current image block and determining whether the reference block is available;
a pixel value filling module, configured to: if the reference block is unavailable, and at least one other neighboring block is available, obtain a pixel value of a pixel point in an available neighboring block, and fill the corresponding pixel point in the unavailable reference block with the obtained pixel value of the pixel point in the available neighboring block as a reference pixel value of the pixel point in the current image block; and
a predicting module, configured to predict the pixel value of the pixel point in the current image block according to the reference pixel value.

13. The apparatus according to claim 12, wherein a neighboring block is available as a reference block if the neighboring block is located inside the image where the current image block is located, the neighboring block and the current image block are located in the same slice of the image, and the neighboring block has already been encoded or decoded.

14. The apparatus according to claim 12, wherein a neighboring block is unavailable as a reference block if:
the neighboring block is located outside the image where the current image block is located, or
the neighboring block and the current image block are located in different slices of the image, or
the neighboring block has not already been encoded or decoded.

15. The apparatus according to claim 12, wherein filling the corresponding pixel point in the unavailable reference block with the obtained pixel value in the neighboring block comprises:
when the upper side block is the unavailable reference block, and if the left side block is available, filling the corresponding pixel point in the upper side block with the obtained pixel value of the pixel point in the left side block;
when the left side block is the unavailable reference block, and if the upper side block is available, filling the corresponding pixel point in the left side block with the obtained pixel value of the pixel point in the upper side block;
when the upper left block is the unavailable reference block, and one of the left side block and upper side block is available, filling the corresponding pixel point in the upper left block with the obtained pixel value of the pixel point in the available one of the left side block and upper side block; and
when the upper left block is the unavailable reference block, and both the left side block and upper side block are available, obtaining an average value for the pixel values of the pixel point in the left side block and the pixel point in the upper side block and filling the corresponding pixel point with the average value.

16. The apparatus according to claim 15, wherein obtaining an average value for the pixel values of the pixel point in the left side block and the pixel point in the upper side block and filling the corresponding pixel point with the average value comprises:
obtaining a pixel value of a pixel point in the left side block that is closest to a pixel point at an upper left corner of the current image block and a pixel value of a pixel point in the upper side block that is closest to the pixel point at the upper left corner of the current image block, and calculate an average value of the two pixel values; and
filling the average value to a lower right corner of the upper left block.

17. The apparatus according to claim 12, wherein the corresponding pixel point in the reference block is a pixel point located along a prediction direction and is closest to the current image block.

18. The apparatus according to claim 12, wherein obtaining a pixel value of a pixel point in an available neighboring block, and filling the corresponding pixel point in the unavailable reference block with the obtained pixel value of the pixel point in the available neighboring block comprises:
obtaining a pixel value from pixel points in the available neighboring block that are nearest to a pixel point at an upper left corner of the current image block; and
filling the pixel value to the corresponding pixel point in the unavailable reference block.

19. An apparatus for encoding or decoding an image, comprising a non-transitory medium storing a software program for predicting pixel values of pixel points in image blocks, the program comprising the following functional modules:
a determining module, configured to, for a pixel point in a current image block, determine a corresponding pixel point in a reference block according to a predetermined prediction direction, wherein the current image block has a left side block, an upper side block, an upper left block and a upper right block as its neighboring blocks, and the reference block is one of the neighboring blocks;
a prediction direction reversing module, configured to, if the prediction direction points to the upper right block as the reference block, the upper right block is unavailable, and the left side block is available, reverse the prediction direction so that it points to a lower side block of the current image block;
a pixel value filling module, configured to obtain a pixel value of a pixel point in the left side block, and filling a pixel point in the lower side block of the current image block which the reversed prediction direction points to with the obtained pixel value as a reference pixel value of the pixel point in the current image block; and
a predicting module, configured to predict the pixel value of the pixel point in the current image block according to the reference pixel value.

20. The apparatus according to claim 19, wherein the upper right block is unavailable if:
the upper right block is located outside an image where the current image block is located; or
the upper right block and the current image block are located at different slices of the image; or
the upper right block has not been encoded or decoded.
